(19) United States
(12) Patent Application Publication
(10) Pub. No.: US 2003/0209858 A1
(43) Pub. Date: Nov. 13, 2003

(54) Sealing device for rolling contact bearings

(75) Inventors: Carlo Maldera, Giaveno (IT); Angelo Vignotto, Torino (IT); Stefano Bertalmio, Pinerolo (IT)

Correspondence Address: MERCHANT & GOULD PC, P.O. BOX 2903, MINNEAPOLIS, MN, 55402-0903, US

(73) Assignee: SKF INDUSTRIE S.p.A., Torino (IT)

(21) Appl. No.: 10/385,232

(22) Filed: Mar. 10, 2003

(30) Foreign Application Priority Data
Mar. 14, 2002 (IT) TO2002A000221

(51) Int. Cl. F16J 15/38

(52) U.S. Cl. 277/394; 277/549

(57) ABSTRACT

Sealing device (1) for rolling contact bearings, the device (1) presenting two rigid shields (3, 4) which face each other in order to form a labyrinth opening (13) which is radially delimited towards the inside by a lateral surface (12), and by a encoder wheel (2) which is supported by a first shield (3) of the said two shields (3, 4) and which is arranged in such a way as to be radially aligned to the labyrinth opening (13); at least one sealing lip (20) being situated inside the labyrinth opening (13), and extending towards the said first shield (3) starting from a second shield (4) of the said two shields (3, 4) in order to face the said lateral surface (12).

### DESCRIPTION

The present invention relates to a sealing device for rolling contact bearings.

In general, sealing devices for rolling contact bearings comprise two rigid shields which face each other in order to form an internal cavity which presents a labyrinth opening, and a encoder wheel which is supported by one of the two rigid shields and which is arranged in such a way as to be radially aligned in relation to the labyrinth opening in order to radially delimit the labyrinth opening itself.

In particularly arduous conditions and in the presence of contaminating agents such as dust, mud and similar phenomena, it is possible that the particles included in such contaminating agents might be attracted by the magnetic material of which, as is well-known, the encoder wheel is made up of, and such contaminating agents might become blocked inside the labyrinth opening, thus causing a series of disadvantages arising from the increase in friction between the rotating parts and also arising from the consequent wear and tear on the said parts themselves. In particular, such said disadvantages can result in problems relating to rotation, as well as problems relating to the reduction of the efficiency of the sealing effect as a result of the enlargement of the labyrinth opening.

Furthermore, sealing devices of the type which have just been described suffer from another series of disadvantages, which are due to the fact that the efficiency of the sealing effect of the labyrinth opening is greatly influenced by the correspondence of the real dimensions of the labyrinth opening itself in relation to the projected dimensions. It must be said that, in many cases, such correspondence is not maintained due to errors which arise for reasons relating to assembly, manufacture and application errors.

The aim of the present invention is to produce a sealing device for rolling bearings which will be totally free of the disadvantages which have just been described above.

According to the present invention a sealing device for rolling bearings will be produced, the device comprising two rigid shields which face each other in order to form a labyrinth opening which is radially delimited towards the inside by a lateral surface, and a encoder wheel which is supported by a first shield of the said two shields and which is radially arranged in such a way as to be aligned in relation to the labyrinth opening; the sealing device being characterised by the fact of comprising at least one sealing lip, which is situated inside the labyrinth opening, and which extends towards the said first shield starting from a second shield of the said two shields in order to face the said lateral surface.

The present invention will now be described with reference to the attached drawings, which illustrate a non-limiting form of embodiment of the present invention, in which:

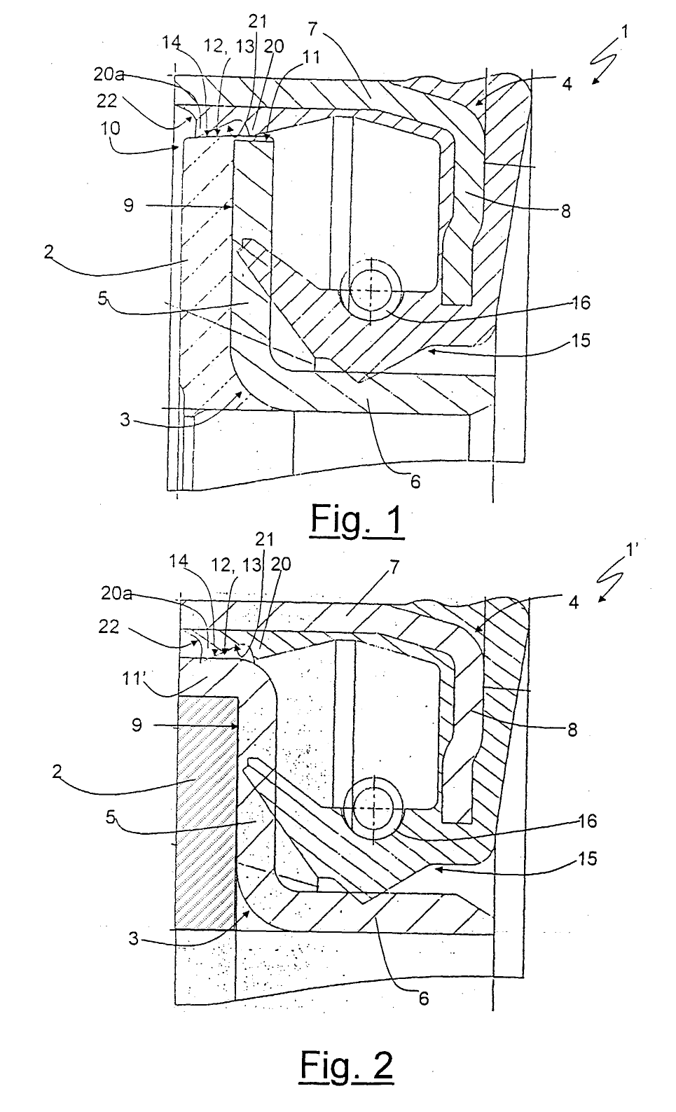

FIG. 1 illustrates, with some parts in section and some parts removed for reasons of clarity, a first preferred form of embodiment of the sealing device for rolling contact bearings according to the present invention;

FIG. 2 illustrates, with some parts in section and some parts removed for reasons of clarity, a second preferred embodiment of the sealing device for rolling contact bearings as shown in FIG. 1.

With reference to FIG. 1, the number 1 refers to a sealing device for rolling contact bearings in its entirety.

The device 1 comprises an encoder wheel 2, and two rigid shields 3 and 4 which face each other, of which the shield 3 presents an internal cylindrical wall 5 and an annular wall 6 which is transverse to the cylindrical wall 5 and which supports the encoder wheel 2, while the shield 4 presents an external cylindrical wall 7 which is coaxial to the cylindrical wall 5 and which is partially overlapped in an axial direction by the encoder wheel 2, and an annular wall 8 which is substantially transverse to the cylindrical wall 7 and which is parallel to the annular wall 6.

The encoder wheel 2 is arranged on an external side 9 of the annular wall 6, and comprises a cylindrical end portion 10, which is made up of the same material as that which constitutes the encoder wheel 2 itself, and which covers a cylindrical end edge 11 of the annular wall 6. The cylindrical portion 10 is radially delimited towards the outside by a lateral surface 12, which defines with the cylindrical wall 5 a labyrinth opening 13, and which presents a conical chamfered edge 14 which tapers towards the outside of the opening 13 itself.

The device 1 also comprises a seal 15 which is anchored to the annular wall 8 and which is arranged in sliding contact with the shield 3, and also comprises a labyrinth spring 16 which is incorporated into the seal 15 and which is suitable for generating a sliding pressure of the seal 15 onto the shield 3 itself.

Finally, the device 1 comprises two sealing lips 20, which are supported by the cylindrical wall 7, and which are axially collocated in series with each other inside the opening 13, and which extend towards the shield 6 in order to define between themselves and in relation to the surface 12 a chamber which ensures an anti-pumping effect.

In the form of embodiment which is illustrated in FIG. 1, both the lips 20 are arranged in sliding contact with the surface 12, but, due to technical necessities, according to some forms of embodiment which are not illustrated but which are, however, easily understandable from the above description, one of the two lips 20, if not both of the two lips 20, only faces the lateral surface 12 without coming into contact with the latter.

The lip 20a, which of the two lips 20 is that which is axially positioned further to the outside of the opening 13, is arranged in sliding contact with the chamfered edge 14, and is axially delimited by an annular centrifugal surface 22 which presents a substantially curved shape with its own concavity turned towards the outside of the opening 13.

The presence of the two lips 20, as well as the conformation of the surface 22 and the chamfered edge 14, contribute to create a barrier which prevents contaminating agents from penetrating between the two shields 3 and 4, and also contributes to providing an overall centrifugal effect towards the outside of the opening 13 itself in relation to the contaminating agents themselves.

Taking into account technical reasons which stem from, for example, the interests relating to ensuring cost-effective manufacture amd a reduced axial dimension, the device 1 may be provided with a single lip 20, as the surface 13 may also be deprived of the chamfered edge 14 in such a way as to present a totally cylindrical shape.

The form of embodiment which is illustrated in FIG. 2 relates to a device 1′ which is similar to the device 1, from which the device 1′ differs due to the fact that the annular wall 6 does not end in the cylindrical edge 11, but ends instead in an end portion 11′ which is turned towards the outside of the opening 12, and which is radially arranged towards the outside of the encoder wheel 2 in such a way as to completely separate the cylindrical end portion 10 from the opening 13.

In this case, the surface 12 is defined by the same tapering end portion 11′, and it may be totally cylindrical as shown in FIG. 2 or it may be provided with a chamfered edge 14 as has been previously described.

It is not intended that the present invention should be limited to the forms of embodiment herein described and illustrated, which are to be considered as forms of embodiment of a sealing device for rolling bearings and which might be susceptible to further modifications relating to the shape and disposition of the parts, as well as to details pertaining to construction and assembly.

1. Sealing device (1)(1′) for rolling contact bearings, the device (1)(1′) comprising two rigid shields (3, 4) which face each other in order to form a labyrinth opening (13) which is radially delimited towards the inside by a lateral surface (12), and a encoder wheel (2) which is supported by a first shield (3) of the said two shields (3, 4) and which is radially arranged in such a way as to be aligned in relation to the labyrinth opening (13); the sealing device (1) (1′) being characterised by the fact of comprising at least one sealing lip (20), which is situated inside the labyrinth opening (13), and which extends towards the said first shield (3) starting from a second shield (4 of the said two shields (3, 4) in order to face the said lateral surface (12).

2. Sealing device according to claim 1, characterised by the fact that the said lateral surface (12) presents a cylindrical shape.

3. Sealing device according to claim 1, characterised by the fact that the said lateral surface (12) comprises a conical portion (14) which tapers towards the outside of the said labyrinth opening (13).

4. Sealing device according to claims 2 or 3, characterised by the fact that the said first shield (3) comprises an annular wall (6) which is axially arranged adjacent to the said encoder wheel (2) and which presents an end portion (11) which is covered with a material which constitutes the encoder wheel (2) itself.

5. Sealing device according to claims 2 or 3, characterised by the fact that the said first shield (3) comprises an annular wall (6) which is axially arranged adjacent to the said encoder wheel (2) and which presents an end portion (11′) which is radially arranged outside of the encoder wheel (2) itself.

6. Sealing device according to whatsoever of any of the above-mentioned claims, characterised by the fact that the said sealing lip (20) is substantially turned towards the outside of the labyrinth opening (13), and is axially delimited by an annular centrifugal surface (22) which presents a substantially curved shape with its own concavity turned towards the outside of the labyrinth opening (13) itself.

7. Sealing device according to claim 6, characterised by the fact that it comprises two sealing lips (20) which are axially arranged in series in relation to each other inside the said labyrinth opening (13) in order to define in relation to each other and in relation to the said lateral surface (12) a chamber (21) which ensures an anti-pumping effect.

8. Sealing device according to claim 7, characterised by the fact that at least one of the two lips (2) is arranged in sliding contact with the said lateral surface (12).
